(19) United States
(12) Patent Application Publication
(10) Pub. No.: US 2026/0235932 A1
(43) Pub. Date: Aug. 13, 2026

(54) LIGHT-EMITTING DEVICE, FLASH DEVICE, IMAGING SYSTEM, AND IMAGING METHOD

(71) Applicant: CANON KABUSHIKI KAISHA, Tokyo (JP)

(72) Inventor: YASUHIKO SANO, Kanagawa (JP)

(21) Appl. No.: 19/533,849

(22) Filed: Feb. 9, 2026

(30) Foreign Application Priority Data
Feb. 12, 2025 (JP) 2025-021074

(51) Int. Cl. G03B 15/05; H05B 41/32; H05B 41/34

(52) U.S. Cl. CPC G03B 15/05; H05B 41/32; H05B 41/34; G03B 2215/0514

(57) ABSTRACT

A light-emitting device includes: a switching element configured to control the supply of the electric power to a light-emitting component; and an inductor connected between the light-emitting component and a capacitor, having: a first emission mode in which the switching element is turned ON to cause the light-emitting component to emit light over a first period, and thereafter the switching element is turned OFF; and a second emission mode in which the ON and OFF of the switching element are repeated to cause the light-emitting component to perform continuous light emission over a second period longer than the first period, the inductor includes a core coil having a magnetic core, the core coil has a first inductance value during a peak current in the first emission mode, and has a second inductance value during an average current in the second emission mode, which is greater than the first inductance value.

### BACKGROUND

### Field of the Technology

The aspect of the embodiments relates to a light-emitting device, a flash device, an imaging system, and an imaging method.

### Description of The Related Art

Japanese Patent Laid-Open No. 2024-152041 discloses a flash light-emitting device having a flash emission mode and a flat emission mode (focal plane emission mode). In the flash light-emitting device described in Japanese Patent Laid-Open No. 2024-152041, an inductor is used for limiting a current supplied to a flash discharge tube.

However, the flash light-emitting device described in Japanese Patent Laid-Open No. 2024-152041 has difficulty in operating with an optimum inductance value of the inductor in either the flash emission mode or the flat emission mode.

### SUMMARY

According to one aspect of the embodiments, there is provided light-emitting device including: a light-emitting component configured to emit light upon receiving a supply of electric power; a capacitor configured to supply the electric power to the light-emitting component; a switching element configured to control the supply of the electric power by turning ON and OFF; and an inductor connected between the light-emitting component and the capacitor, the light-emitting device having: a first emission mode in which the switching element is turned ON to cause the light-emitting component to emit light over a first period, and thereafter the switching element is turned OFF; and a second emission mode in which the ON and OFF of the switching element are repeated to cause the light-emitting component to perform continuous light emission over a second period longer than the first period, wherein the inductor includes a core coil having a magnetic core, wherein the core coil has a first inductance value during a peak current in the first

emission mode, and has a second inductance value during an average current in the second emission mode, and wherein the second inductance value is greater than the first inductance value.

Features of the disclosure will become apparent from the following description of embodiments with reference to the attached drawings. The following description of embodiments is described by way of example.

### BRIEF DESCRIPTION OF THE DRAWINGS

FIG. 1A is a front view illustrating a flash light-emitting device and an imaging device included in an imaging system according to a first embodiment.

FIG. 1B is a side view illustrating the flash light-emitting device and the imaging device included in the imaging system according to the first embodiment.

FIG. 2 is a block diagram illustrating an electric circuit of the flash light-emitting device according to the first embodiment.

FIG. 3 is a graph showing direct current superposition characteristics of an inductor in the flash light-emitting device according to the first embodiment.

FIG. 4A is a graph showing a current waveform in the flash emission mode of the flash light-emitting device according to the first embodiment.

FIG. 4B is a graph showing a current waveform in the flat emission mode of the flash light-emitting device according to the first embodiment.

FIG. 4C is a graph showing a current waveform in the flat emission mode of the flash light-emitting device according to the first embodiment.

FIG. 5 is a graph showing a ripple amount when the inductance of the flash light-emitting device according to the first embodiment is changed.

FIG. 6 is a block diagram illustrating an electric circuit of a flash light-emitting device according to a second embodiment.

FIG. 7 is a graph showing direct current superposition characteristics of an inductor in the flash light-emitting device according to the second embodiment.

FIG. 8 is a graph showing the ripple amount during flat emission in Example 1 and a comparative example.

FIG. 9 is a graph showing the direct current superposition characteristics of the inductor in Example 1 and the comparative example.

FIG. 10 is a graph showing the ripple amount during flat emission in Example 2 and a comparative example.

FIG. 11 is a graph showing the direct current superposition characteristics of the inductor in Example 2 and the comparative example.

### DESCRIPTION OF THE EMBODIMENTS

### Related Art

Flash light-emitting devices, which are light-emitting devices that emit a flash of light, are mainly used as an option for digital video cameras and digital still cameras. These imaging devices such as digital video cameras and digital still cameras are provided with an imaging module having an image sensor. The flash light-emitting device has a flash emission mode in which light is emitted with relatively high luminance only once, and a flat emission mode (focal plane emission mode) in which light is emitted with lower luminance and for a long duration compared with the flash emission mode by repeatedly turning a switching element ON and OFF in a continuous manner.

Furthermore, the flash light-emitting device includes an inductor to limit light emitting current to a flash discharge tube such as a xenon tube (Xe tube) or the like, which is a light-emitting component. In the flash emission mode, the inductor is used to suppress a steep rise of the current. On the other hand, in the flat emission mode, the inductor is used to suppress fluctuations of the current accompanying the ON and OFF of the switching element, thereby obtaining substantially uniform luminance when light is emitted. When the fluctuations of the current, that is, the fluctuations of the luminance are large in the flat emission mode, the fluctuations are detected by the image sensor, and as a result, horizontal stripe-like image noise called flicker noise is generated, which leads to a reduction in the image quality of the images obtained by the imaging device.

The inductance value required for the inductor described above is, in the flash emission mode, required to be relatively small in order to quicken the rise and fall of the current for good emission cutoff, and also to limit the current so that the current does not exceed a specified current. On the other hand, in the flat emission mode, a greater inductance value compared to the flash emission mode is used as the inductance value of the inductor, in order to suppress fluctuations of the current and thus achieve substantially uniform emission. Therefore, the optimal inductance values differ between the two modes in a flash light-emitting device having a flash emission mode and a flat emission mode.

In the light-emitting device described in Japanese Patent Laid-Open No. 2024-152041, an air-core coil is mainly used as an inductor for current limitation. For this reason, in the light-emitting device described in Japanese Patent Laid-Open No. 2024-152041, the inductance value of the inductor is not changed between the flash emission mode and the flat emission mode, and the optimum inductance value cannot be obtained in both modes.

Furthermore, even when a magnetic core is used for the inductor, the magnetic material of the inductor is magnetically saturated in both the flash emission mode and the flat emission mode in which the current is smaller than that of the flash emission mode. For this reason, when the magnetic core is used, the change of the inductance value becomes small in both modes, and the optimum operation cannot be performed.

In contrast, the light-emitting device according to the embodiments of the disclosure realizes operation with a more appropriate inductance value of the inductor with a simpler configuration in both the flash emission mode and the flat emission mode. Hereinafter, embodiments for carrying out the disclosure will be described in detail with reference to the drawings.

### First Embodiment

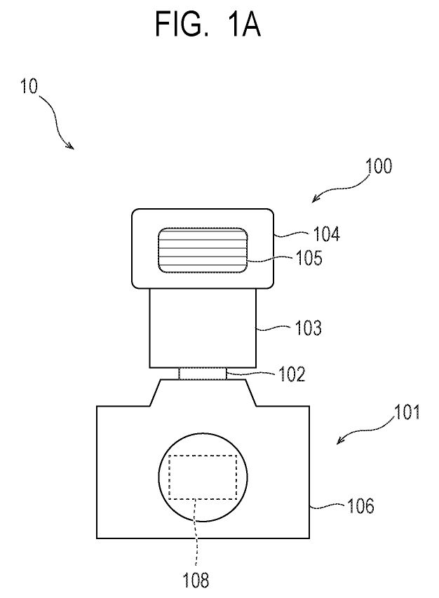

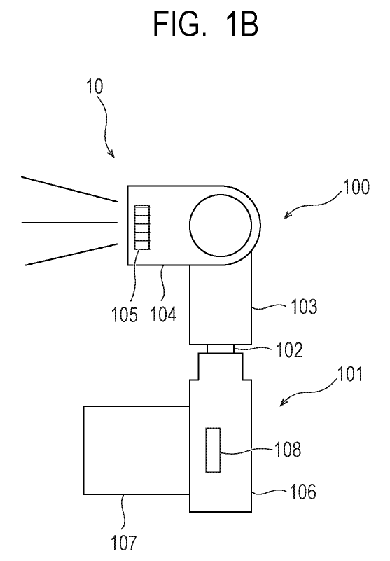

A light-emitting device, an imaging system, and an imaging method according to a first embodiment will be described with reference to FIGS. 1A to 5. In the embodiment and a second embodiment, a flash light-emitting device that emits a flash of light and includes a flash discharge tube as a light-emitting component will be described as an example of the light-emitting device. Note that the disclosure is not limited to the flash light-emitting device but can be widely applied to light-emitting devices that emit light.

First, an imaging system according to the embodiment will be described with reference to FIGS. 1A and 1B. FIGS. 1A and 1B are schematic diagrams illustrating a flash light-emitting device 100 and an imaging device 101 included in the imaging system 10 according to the embodiment, respectively. FIG. 1A is a front view, and FIG. 1B is s side view.

As illustrated in FIGS. 1A and 1B, the imaging system 10 according to the embodiment includes the flash light-emitting device 100 and an imaging device 101. For example, the imaging device 101 is a camera, and the flash light-emitting device 100 is a flash device (strobe device), which is attachable to and detachable from the camera. Note that FIGS. 1A and 1B show the flash light-emitting device 100 and the imaging device 101 in a clip-on state.

The flash light-emitting device 100 is electrically and physically connected to the imaging device 101 via an accessory shoe 102. The flash light-emitting device 100 is controlled to emit light by a signal from the imaging device 101. The imaging device 101 can capture an image of a subject while making the flash light-emitting device 100 emit light in the flash emission mode or in the flat emission mode by controlling the flash light-emitting device 100.

In the imaging system 10 according to the embodiment, the flash light-emitting device 100 and the imaging device 101 are in the clip-on state in which the flash light-emitting device 100 is arranged on the accessory shoe 102 of the imaging device 101. Note that the flash light-emitting device 100 and the imaging device 101 may be in other states such as a bracket state, in addition to the clip-on state. The bracket state is a state where the flash light-emitting device 100 is connected to the accessory shoe 102 via an off-camera shoe cord, and the flash light-emitting device 100 and the imaging device 101 are arranged in a lateral direction. In the imaging system 10, the flash light-emitting device 100 and the imaging device 110 can be set in the clip-on state, the bracket state, or other states, depending on a photographing purpose, a photographing state, or the like.

The flash light-emitting device 100 includes a first housing 103, a second housing 104, and a flash discharge tube 105 as a light-emitting component. A battery, a power supply circuit, or the like (not illustrated) for supplying power to the flash light-emitting device 100 is provided in the first housing 103. The flash discharge tube 105 is provided in the second housing 104. The second housing 104 has a rotation mechanism and is provided on the first housing 103 so as to be rotatable by the rotation mechanism. Thereby, the second housing 104 is configured to be able to rotate and change the direction of light emission from the flash discharge tube 105. The flash discharge tube 105 emits light emission according to a signal from the imaging device 101 to irradiate a subject (not illustrated) with light.

The imaging device 101 includes a housing 106, an interchangeable lens 107, an image sensor 108, and the accessory shoe 102. The interchangeable lens 107 is configured to be attachable to and detachable from the housing 106. The image sensor 108 is provided in the housing 106. The image sensor 108 is, for example, an image sensor such as a CMOS (Complementary Metal-Oxide Semiconductor) sensor or the like, although not particularly limited. The interchangeable lens 107 converges or diverges light from the subject to form a subject image on the image sensor 108. The image sensor 108 is an element in which photoelectric conversion elements, which convert light from the interchangeable lens 107 into electrical signals, are arranged in an array. The accessory shoe 102 is a hot shoe and is provided on an outside portion of the housing 106, such as the upper portion of the housing 106 or the like.

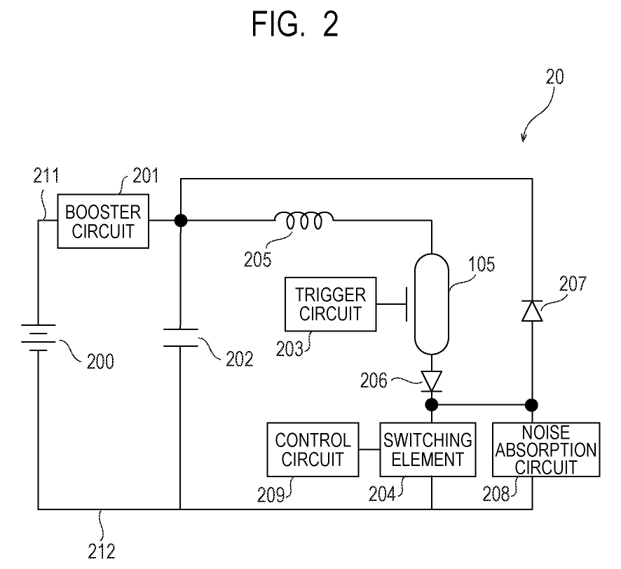

Next, the configuration of the flash light-emitting device 100 will be described with reference to FIG. 2. FIG. 2 is a block diagram illustrating the electric circuit 20 of the flash light-emitting device 100.

As illustrated in FIG. 2, the electric circuit 20 in a flash light-emitting device 100 includes the flash discharge tube 105, a power supply 200, a booster circuit 201, a capacitor 202, a trigger circuit 203, and a switching element 204. The electric circuit 20 also includes an inductor 205, a diode 206, a freewheeling diode 207, a noise absorption circuit 208, and a control circuit 209.

One terminal of the inductor 205 is connected via the booster circuit 201 to a power supply line 211 connected to the positive electrode of the power supply 200. The anode of the flash discharge tube 105 is connected to the other terminal of the inductor 205. The cathode of the flash discharge tube 105 is connected to the anode of the diode 206. The cathode of the diode 206 is connected to one terminal of the switching element 204. The other terminal of the switching element 204 is connected to a ground line 212 connected to the negative electrode of the power supply 200. One terminal of the capacitor 202 is connected between the booster circuit 201 and the one terminal of the inductor 205. The other terminal of the capacitor 202 is connected to the ground line 212. The anode of the freewheeling diode 207 is connected between the cathode of the diode 206 and the one terminal of the switching element 204. The cathode of the freewheeling diode 207 is connected to the one terminal of the capacitor 202, which is connected to the booster circuit 201 and the one terminal of the inductor 205. The anode of the freewheeling diode 207 is connected to the ground line 212 via the noise absorption circuit 208. The noise absorption circuit 208 is connected in parallel with the switching element 204. The trigger circuit 203 is arranged to be able to apply a pulse voltage to the flash discharge tube 105.

The flash discharge tube 105 is a light-emitting component in which noble gas such as xenon or the like is sealed in a glass tube such as quartz, high silica, or the like, and electrodes of an anode and a cathode are provided at both ends to make the tube sealed, and is a light-emitting component that emits light upon receiving a supply of electric power. Note that the light-emitting component used for the flash light-emitting device 100 can be selected from light sources such as incandescent light emission, discharge light emission, electroluminescence, photoluminescence, or the like, and in one embodiment, the flash discharge tube 105 such as a xenon lamp or the like is used, but a solid-state light-emitting component such as a light-emitting diode may be used.

The power supply 200 is a power source of, for example, about several volts to 10 volts for supplying electric power to the flash discharge tube 105, and specifically includes a lithium-ion battery, a nickel-metal hydride battery, or the like.

The booster circuit 201 is a circuit for converting the voltage received from the power supply 200 to, for example, about several hundred volts, and is a DC/DC converter or the like.

The capacitor 202 is a capacitor that accumulates electric charges supplied from the booster circuit 201, generally has a capacity of about several hundred μF to 1500 μF, for example, and is an electrolytic capacitor for flash adapted to instantaneous discharge. The capacitor 202 supplies electric power for making the flash discharge tube 105 emit light to the flash discharge tube 105 by the accumulated electric charges.

The trigger circuit 203 is a circuit for generating a high voltage of about several thousand volts, for example, and applying the high voltage to the flash discharge tube 105 via a trigger electrode in order to excite the flash discharge tube 105 to promote light emission.

The switching element 204 is a circuit that controls the amount of current flowing to the flash discharge tube 105. The switching element 204 is, for example, a switching element using an IGBT (Insulated Gate Bipolar Transistor) but not particularly limited. Alternatively, the switching element 204 may be, for example, a switching element that is a compound semiconductor element using a compound semiconductor such as GaN (Gallium Nitride), SiC (Silicon Carbide), or the like. The switching element 204 controls power supply from the capacitor 202 to the flash discharge tube 105 by an ON and OFF switching operation. The control circuit 209 for controlling the switching operation of the switching element 204 is connected to the switching element 204. The control circuit 209 functions as a control unit that controls the flash discharge tube 105 to emit light in the flash emission mode or the flat emission mode by controlling the switching element 204.

The inductor 205 is a choke coil that limits a current supplied from the capacitor 202 to the flash discharge tube 105. The inductor 205 is an inductor element which is a core coil having a magnetic core. As the magnetic core, a core composed of a soft magnetic material such as ferrite, permalloy, or the like is used, although not particularly limited.

The diode 206 is a diode for preventing a current from flowing back to the flash discharge tube 105. The freewheeling diode 207 is a diode for returning energy accumulated in the coil of the inductor 205 to the capacitor 202 when power supply to the flash discharge tube 105 is cut off by turning OFF the switching element 204.

The noise absorption circuit 208 is a protection circuit for absorbing a transient high frequency component generated when the switching element 204 is turned ON and OFF. As the noise absorption circuit 208, a snubber circuit or the like in which a resistor and a capacitor are connected in series is used.

The flash light-emitting device 100 has the flash emission mode and a flat emission mode, and can operate in either the flash emission mode or the flat emission mode. The flash emission mode is a mode in which the flash discharge tube 105 emits a flash of light only once during a shutter operation. The focal plane emission mode is a mode in which the flash discharge tube 105 repeatedly and continuously emits a flash of light multiple times during a shutter operation. The flat emission mode is an emission mode that performs low-luminance and long-duration emission compared to the flash emission mode.

First, the operation of the flash light-emitting device 100 in the flash emission mode will be described with reference to FIGS. 1A to 2. The flash light-emitting device 100 can operate in the flash emission mode and emit a flash of light only once during a shutter operation in an imaging method that captures an image of a subject by the imaging device 101 using the imaging system 10 including the flash light-emitting device 100 and the imaging device 101.

In the operation in the flash emission mode, first, in response to a signal input from the imaging device 101, the power supply 200 supplies power to the booster circuit 201, and the booster circuit 201 starts the operation of boosting and outputting the voltage. When the booster circuit 201 starts operating, charge is supplied to the capacitor 202, and charging of the capacitor 202 begins. When the charging voltage in the capacitor 202 reaches the voltage required for light emission, the flash light-emitting device 100 illuminates its indicator (not illustrated) to indicate that light emission is possible.

Next, when the photographer releases the shutter of the imaging device 101, a signal for starting light emission is transmitted from the imaging device 101 to the flash light-emitting device 100 via the accessory shoe 102. Upon receiving the signal, the flash light-emitting device 100 changes the switching element 204 from the OFF state to the ON state by the control circuit 209, and then applies a high voltage pulse, which is a pulse voltage to be a trigger signal from the trigger circuit 203 to the flash discharge tube 105. The high voltage pulse ionizes the gas inside the flash discharge tube 105, and the impedance inside the flash discharge tube 105 becomes low. Then, a closed circuit is formed by the inductor 205, the flash discharge tube 105, the diode 206, and the switching element 204 in the ON state. This causes the electric charge of the capacitor 202 to start discharging through the flash discharge tube 105, transitioning the flash discharge tube 105 to a light emitting state. At this time, the inductor 205 limits the current due to the discharge of the capacitor 202 to suppress a sharp increase in the current. The control circuit 209 changes the switching element 204 to the OFF state when the control circuit 209 detects that the current reaches a specified value Isingle [A] for the flash emission mode. By changing the switching element 204 to the OFF state, the energy accumulated in the inductor 205 is regenerated or recovered to the capacitor 202 via the freewheeling diode 207. As a result, the current flowing in the flash discharge tube 105 gradually decreases, and the light emission of the flash light-emitting device 100 by the operation in the flash emission mode ends. Thus, the flash light-emitting device 100 operating in the flash emission mode turns ON the switching element 204 while the flash discharge tube 105 emits light over a first period, after which the flash light-emitting device 100 turns OFF the switching element 204. The first period is, for example, less than 1 msec, and may be 500 μsec or less, may be 100 μsec or less, or may be 50 μsec or less. The first period is, for example, 1 μsec or more, may be 5 μsec or more, or may be 10 μsec or more.

Next, the operation in the flat emission mode will be described with reference to FIGS. 1A to 2. The flash light-emitting device 100 can operate in the flat emission mode and can repeatedly and continuously emit a flash of light a plurality of times during

shutter operation in an imaging method that captures an image of a subject by the imaging device 101 using the imaging system 10 including the flash light-emitting device 100 and the imaging device 101.

In the operation in the flat emission mode, first, in response to a signal input from the imaging device 101, the power supply 200 supplies power to the booster circuit 201, and the booster circuit 201 starts the operation of boosting and outputting the voltage. When the booster circuit 201 starts operating, charge is supplied to the capacitor 202 and the charging of the capacitor 202 begins. When the charging voltage in the capacitor 202 reaches the voltage required for light emission, the flash light-emitting device 100 illuminates its indicator (not illustrated) to indicate that light emission is possible.

Next, when the photographer releases the shutter of the imaging device 101, a signal for starting light emission is transmitted from the imaging device 101 to the flash light-emitting device 100 via the accessory shoe 102. Upon receiving the signal, the flash light-emitting device 100 changes the switching element 204 from the OFF state to the ON state by the control circuit 209, and then applies a high voltage pulse, which is a pulse voltage to be a trigger signal from a trigger circuit 302 to the flash discharge tube 105. The high voltage pulse ionizes the gas inside the flash discharge tube 105, and the impedance inside the flash discharge tube 105 becomes low. Then, a closed circuit is formed by the inductor 205, the flash discharge tube 105, the diode 206, and the switching element 204 in the ON state. This causes the electric charge of the capacitor 202 to start discharging through the flash discharge tube 105, transitioning the flash discharge tube 105 to a light emitting state. At this time, the inductor 205 limits the current due to the discharge of the capacitor 202 to suppress a sharp increase in the current. The control circuit 209 changes the switching element 204 to the OFF state when the control circuit 209 detects that the current reaches a specified value for the flat emission mode. By changing the switching element 204 to the OFF state, the energy accumulated in the inductor 205 is regenerated or recovered to the capacitor 202 via the freewheeling diode 207. Thus, the current flowing in the flash discharge tube 105 gradually decreases.

The operation in the flat emission mode up to this point is the same as the operation in the flash emission mode except that the specified value of the current is different from that in the flash emission mode. In the case of the operation in the flat emission mode, thereafter, the control circuit 209 changes the switching element 204 from the OFF state to the ON state again when the control circuit 209 detects that the current

value becomes equal to or less than a specified threshold. This causes the electric charge of the capacitor 202 to be supplied to the flash discharge tube 105 again, and the current begins to increase again. Thereafter, the switching element 204 is repeatedly turned ON and OFF, and a current with an average current value Iflat [A], which is obtained by averaging current fluctuations due to the ON and OFF operation, is supplied to the flash discharge tube 105. This causes the flash discharge tube 105 to discharge and emit light only for a prescribed time. After emitting light for the prescribed time, the control circuit 209 changes the switching element 204 to the OFF state and continues the OFF state thus to terminate the light emission by the operation in the flat emission mode. Thus, the flash light-emitting device 100 operating in the flat emission mode continuously emits light by the flash discharge tube 105 over a prescribed second period that is longer than the first period of the flash emission mode by repeatedly turning the switching element 204 ON and OFF. The second period is, for example, 1 msec or more, may be 10 msec or more, may be 100 msec or more, or may be 1000 msec or more. The second period is, for example, 1 minute or less, may be 30 seconds or less, or may be 10 seconds or less. Furthermore, the ON period frequency of the switching element 204 in the flat emission mode is, for example, 10 kHz or more, and in one embodiment, 20 kHz or more, may be 100 kHz or more, may be 250 kHz or more, may be 1000 kHz or less, or may be 750 kHz or less is used.

Note that, in one embodiment, the time from when the switching element 204 is turned ON until the switching element 204 is turned OFF in the flash emission mode is longer than the time from when the switching element 204 is turned ON until the switching element 204 is turned OFF in the flat emission mode.

Note that, the light emission of the flash light-emitting device 100 is controlled by detecting whether a specified value is reached or not with a current in the operation of both of the flash emission mode and the flat emission mode here, but the control of the light emission is not limited to this. For example, it is possible to detect the amount of light emission and control the light emission of the flash light-emitting device 100 based on the amount of light emission.

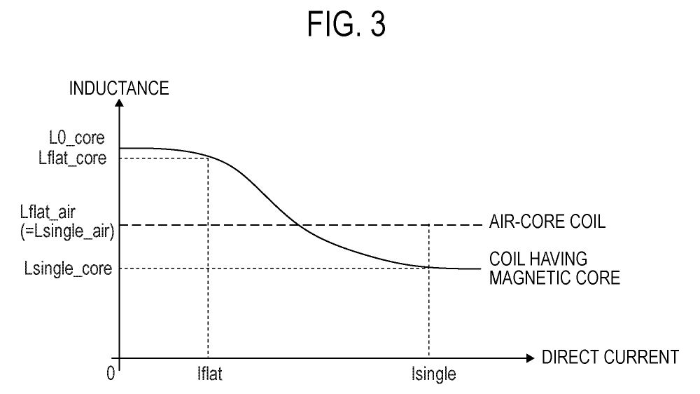

In the flash light-emitting device 100 according to the embodiment, a coil having a magnetic core is used as the inductor 205. FIG. 3 is a graph showing a change in inductance when a direct current is superimposed on a coil having a magnetic core used as the inductor 205 in the flash light-emitting device 100 according to the embodiment. FIG. 3 also shows, as a comparative example, a graph showing a change in inductance when a direct current is superimposed on an air-core coil when the air-core coil used as the inductor 205 is generally used in flash light-emitting devices. The graph in the case of the coil having the magnetic core is shown by a solid line, and the graph in the case of the air-core coil is shown by a broken line.

In FIG. 3, Isingle indicates a peak current value (maximum current value) flowing through the inductor 205 in the flash emission mode, and Iflat indicates an average current value flowing through the inductor 205 in the flat emission mode. The average current value Iflat is smaller than the peak current value Isingle, i.e., one-half or less of the peak current value Isingle. In the flash emission mode, the inductance value of the inductor 205 at the peak current value Isingle is Lsingle_air in the case of the inductor 205 of the air-core coil, and Lsingle_core in the case of the inductor 205 of the coil having the magnetic core. On the other hand, in the flat emission mode, the inductance value of the inductor 205 at the average current value Iflat is Lflat_air in the case of the inductor 205 of the air-core coil, and Lflat_core in the case of the inductor 205 of the coil having the magnetic core. When the direct current is zero amperes, the inductance value of the inductor 205 of the coil having the magnetic core is L0_core.

As shown in FIG. 3, in the case of the inductor 205 of the coil having the magnetic core, when the direct current flows, the magnetic material constituting the magnetic core approaches magnetic saturation, and the permeability of the magnetic core decreases, and the inductance value decreases as the direct current component is increased. This phenomenon is called the direct current superposition characteristic. The direct current superposition characteristic has different characteristics depending on the magnetic material used for the magnetic core and the gap interval provided in the magnetic core, and the like. For example, there are various characteristics such as a characteristic in which the inductance value does not vary greatly up to a certain current value and the inductance value rapidly decreases beyond the certain current value, a characteristic in which the inductance value varies relatively slowly, and the like. In contrast, in the case of the inductor 205 of the air-core coil, the inductance value is substantially constant regardless of the direct current.

Thus, the inductor 205 of the coil having the magnetic core has an inductance value Lsingle_core during a peak current in the flash emission mode and has an inductance value Lflat_core during an average current in the flat emission mode. The inductance value Lflat_core is greater than the inductance value Lsingle_core. As will be described later, in one embodiment, the inductance value Lflat_core is 1.3 times or more the inductance value Lsingle_core.

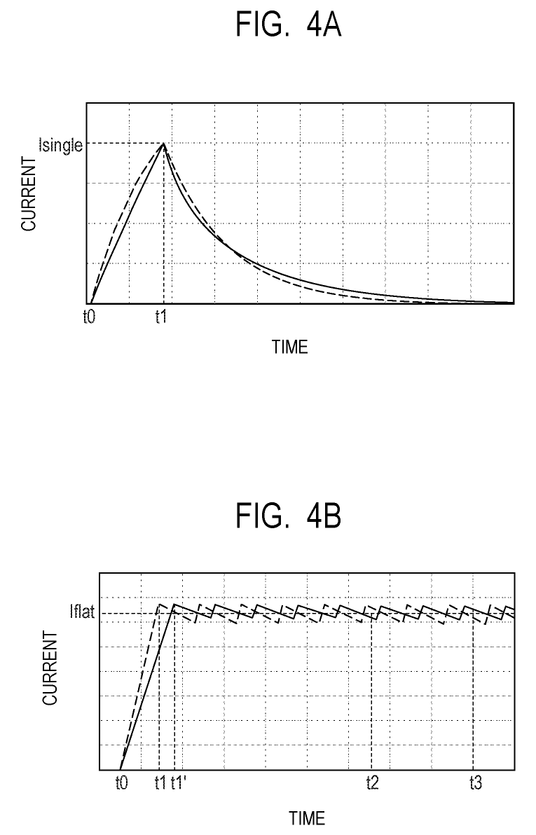

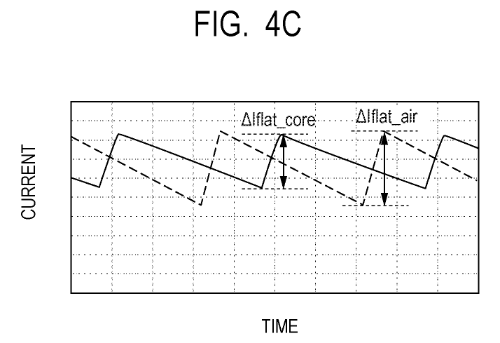

FIGS. 4A to 4C show operation waveforms in the flash emission mode and the flat emission mode respectively in the case where the air-core coil of the comparative example is used, and in the case where the coil having the magnetic core of the embodiment is used, which have the characteristics shown in FIG. 3 as the inductor 205. FIG. 4A shows operation waveforms in the flash emission mode, and FIG. 4B shows operation waveforms in the flat emission mode. FIG. 4C are partly enlarged view of FIG. 4B. In FIGS. 4A to 4C, solid lines show the operation waveforms in the case of the coil having the magnetic core of the embodiment and broken lines show the operation waveforms in the case of the air-core coil of the comparative example. In the graphs of the respective figures, the horizontal axis indicates time and the vertical axis indicates current.

First, the operation waveforms in the flash emission mode will be described with reference to FIG. 4A. In the operation in the flash emission mode shown in FIG. 4A, a trigger signal is applied at time t0, and the switching element 204 is turned from the OFF state to the ON state. Consequently, the current increases while abrupt current fluctuations are suppressed by the inductor 205. At this time, in the case of the air-core coil of the comparative example, a constant inductance value, specifically Lflat_air in FIG. 3, is maintained from time t0 to time t1. Therefore, the operation waveform of the current increases exponentially according to the time constant determined by the inductance value Lflat_air and the resistance component of the circuit (not illustrated). On the other hand, in the case of the magnetic core of the embodiment, the current value increases as time progresses from time t0 to time t1. Therefore, in this case, the inductance value gradually decreases from L0_core, which is a value when the direct current is zero amperes, to Lsingle_core, which is a value when the current of Isingle flows, due to the direct current superposition characteristic shown in FIG. 3. Therefore, in the case of the magnetic core of the embodiment, the current limiting effect by the inductor 205 decreases as time approaches to time t1, and as a result, the operation waveform becomes a more linear waveform as compared with the case of the air-core coil of the comparative example. Note that, although described here as a linear waveform, the waveform is not limited to this, and the waveform becomes such that the current fluctuation with respect to the unit time gradually increases, for example, depending on the direct current superposition characteristic.

Thereafter, after the current reaches the preset current value Isingle at time t1, the switching element 204 is changed from the ON state to the OFF state. As a result, the current gradually decreases and the light emission of the flash light-emitting device 100 by the operation in the flash emission mode ends.

Next, the operation waveforms in the flat emission mode will be described with reference to FIGS. 4B and 4C. In the operation in the flat emission mode shown in FIGS. 4B and 4C, similarly to the operation in the flash emission mode, a trigger signal is applied at time t0 and the switching element 204 is changed from the OFF state to the ON state. Consequently, the current increases while abrupt current fluctuations are suppressed by the inductor 205. Thereafter, after the current reaches a preset prescribed value, the switching element 204 is changed from the ON state to the OFF state, and the current gradually decreases.

As shown in FIG. 4B, in the case of the air-core coil of the comparative example, the switching element 204 is changed to the OFF state at time t1, and in the case of the embodiment, the switching element 204 is changed to the OFF state at time t1′. After a certain time interval, the switching element 204 is turned ON again, causing the current to increase again. In this repetitive ON and OFF operation of the switching element 204, the ON/OFF duty ratio of the switching element 204 is adjusted. By performing such control, the average current becomes Iflat, but the current fluctuates with a certain range according to the ON and OFF operation of the switching element 204. This fluctuation of the current is called ripple, which can lead to flicker noise and cause deterioration of image quality. Therefore, it is important to reduce the ripple. The ripple amount ΔI has a property proportional to the applied voltage and time, and inversely proportional to the inductance. That is, in the vicinity of the average current value Iflat, the greater the inductance value of the inductor 205 becomes, the more the ripple amount ΔI can be reduced.

Here, looking at the inductance values during the average current value Iflat in the flat emission mode operation in FIG. 3, the inductance value in the case of the comparative example is Lflat_air, and the ripple amount ΔI at that time becomes ΔIflat_air as shown in FIG. 4C. On the other hand, the inductance value in the case of the embodiment is Lsingle_core, and the ripple amount at that time becomes ΔIflat_core as shown in FIG. 4C. The ripple amount ΔIflat_core in the case of the embodiment can be made smaller than the ripple amount ΔIflat_air in the case of the comparative example.

In order to obtain an equivalent ripple amount in the case of the air-core coil of the comparative example, the inductor 205 having a large inductance would have to be used. However, in this case, the same large inductance would be obtained also in the case of the flash emission, and the rise time of the current becomes long, making it difficult to perform an optimal light emitting operation.

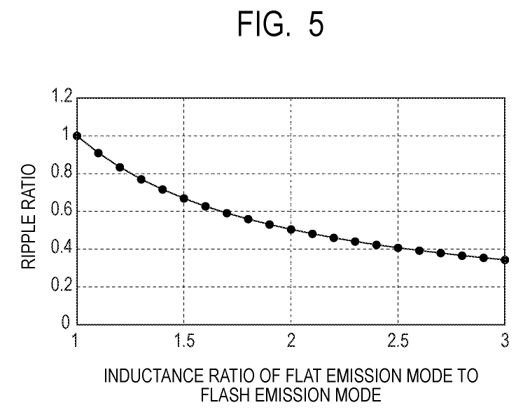

FIG. 5 is a graph plotting the ripple ratio in the flat emission mode against the inductance ratio of the inductance during the average current in the flat emission mode to the inductance during the peak current in the flash emission mode, for the inductor 205 of the embodiment. The ripple ratio is the rate of change in the ripple amount for each inductance ratio, taking the ripple amount when the inductance ratio is 1 as 1. FIG. 5 indicates that the ripple amount can be reduced if the inductance in the flat emission mode is set to be greater than the inductance in the flash emission mode.

In the embodiment, as described above, the inductance value Lflat_core in the flat emission mode is greater than the inductance value Lsingle_core in the flash emission mode. This makes it possible to reduce the ripple amount. More effectively, in one embodiment, the inductance value Lflat_core in the flat emission mode is set to 1.3 times or more the inductance value Lsingle_core in the flash emission mode. This allows the ripple amount to be reduced by 20% or more as compared with the case where the inductance ratio is 1.

Thus, in the embodiment, the inductor 205 of the coil having the magnetic core is used, and the inductance value during the average current in the flat emission mode is made greater than the inductance value during the peak current in the flash emission mode. This makes it possible to perform a more appropriate operation in both of the emission modes.

As described above, according to the embodiment, the flash light-emitting device can be driven with a more appropriate inductance value in both of the emission modes of the flash emission mode and the flat emission mode with a simple configuration, and appropriate light emission can be obtained in either of the emission modes.

### Second Embodiment

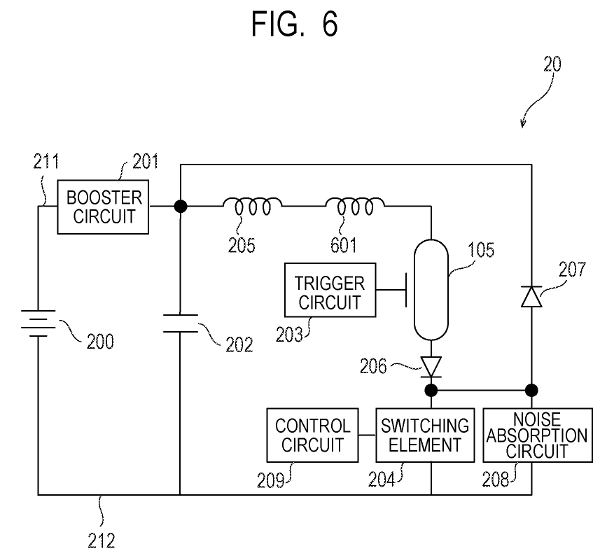

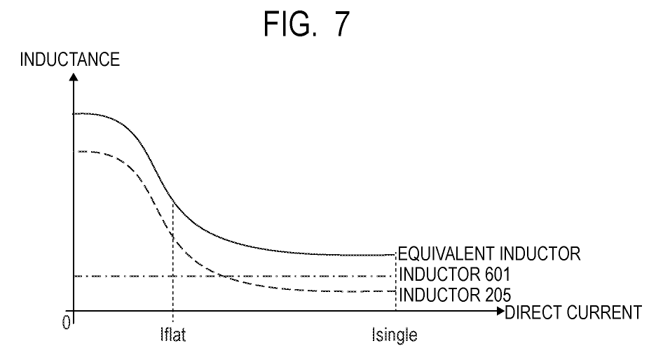

A light-emitting device according to a second embodiment of the disclosure will be described with reference to FIGS. 6 and 7. Note that components similar to those in the first embodiment will be denoted by the same reference numerals and their descriptions will be omitted or simplified.

The basic configuration of the flash light-emitting device 100 according to the embodiment is the same as a configuration of the flash light-emitting device 100 according to the first embodiment. The flash light-emitting device 100 according to the embodiment is different from the flash light-emitting device 100 according to the first embodiment in that it has an inductor 601 which is an air-core coil in addition to the inductor 205.

FIG. 6 is a block diagram illustrating the electric circuit 20 of the flash light-emitting device 100 according to the embodiment. As illustrated in FIG. 6, in the electric circuit 20 of the flash light-emitting device 100 according to the embodiment, the inductor 601 is connected in series with the inductor 205 between the capacitor 202 and the flash discharge tube 105 in a configuration similar to that of the electric circuit 20 according to the first embodiment.

The inductor 601 is an inductor element which is an air-core coil. Specifically, the inductor 601 is connected in series with the inductor 205 between the inductor 205 and the flash discharge tube 105. That is, one terminal of the inductor 601 is connected to the other terminal of the inductor 205. The other terminal of the inductor 601 is connected to the anode of the flash discharge tube 105.

Note that the inductor 601 is to be connected in series with the inductor 205 between the capacitor 202 and the flash discharge tube 105, and may be connected in series with the inductor 205 between the booster circuit 201 and the inductor 205. In this case, one terminal of the inductor 601 is connected to the power supply line 211 via the booster circuit 201. One terminal of the capacitor 202 is connected between the booster circuit 201 and one terminal of the inductor 601. The other terminal of the inductor 601 is connected to one terminal of the inductor 205. The other terminal of the inductor 205 is connected to the anode of the flash discharge tube 105.

The inductor 205, which is a coil having a magnetic core, may have a steep direct current superposition characteristic depending on the properties of the magnetic material forming the magnetic core and the size of the gap in the closed or open magnetic path type. For example, in typical magnetic core coil inductors, a configuration where an air gap is provided in the magnetic core is sometimes used to suppress magnetic saturation. Generally, the direct current superposition characteristic becomes gentle when this air gap is wide, and conversely, the direct current superposition characteristic becomes steep when the air gap is narrow.

In the flash light-emitting device 100, the magnetic field leaked from the air gap of the inductor 205 affects the image sensor 108, and as a result, noise may be generated in an image captured by the imaging device 101. Therefore, the leaked magnetic field may be reduced by reducing the air gap, but thereby the direct current superposition characteristic becomes steep. Also, for example, a saturable inductor, which may be used as the inductor 205, is an inductor that utilizes the magnetic saturation phenomenon and has the characteristic that its inductance value abruptly decreases when a certain current value is exceeded.

By providing the additional inductor 601 when using the inductor 205 with the above-mentioned characteristics, it becomes possible to more suitably adjust the inductance value in the flash emission mode and the inductance value in the flat emission mode.

FIG. 7 is a graph plotting the direct current superposition characteristics of the inductor 205, the added inductor 601 of the embodiment, and the equivalent inductor resulting from the series connection of the inductor 205 and the inductor 601. The graph for the inductor 205 (coil with magnetic core) is shown by a broken line, the graph for the inductor 601 (air-core coil) is shown by a dash-dot line, and the graph for the equivalent inductor is shown by a solid line.

In the case shown in FIG. 7, the inductor 205 exhibits a direct current superposition characteristic steeper than that of the first embodiment, and especially, at the current value Isingle in the flash emission mode, the inductor 205 is in a state where magnetic saturation has almost occurred. Due to this, the inductance value in the flash emission mode for the inductor 205 alone is small, and the current limiting effect cannot be sufficiently obtained when the switching element 204 is in the ON state. To compensate for this decrease in the inductance value of the inductor 205, the inductor 601 is provided in series with the inductor 205 in the embodiment. This equivalent inductor, formed by the series connection of the inductor 205 and the inductor 601, makes it possible to obtain the necessary inductance value during operation in the flash emission mode. Furthermore, the inductance value of the inductor 601 is also added during operation in the flat emission mode, making it possible to obtain a large inductance value, which can efficiently and further suppress the ripple explained in the first embodiment.

In the embodiment, similar to the first embodiment, the equivalent inductance value of the equivalent inductor of the inductor 205 and the inductor 601 is set to be greater during the average current in the flat emission mode than during the peak current in the flash emission mode. This makes it possible to reduce the ripple amount. More effectively, in one embodiment, the equivalent inductance value in the flat emission mode is set to be 1.5 times or more the equivalent inductance value in the flash emission mode. This allows the ripple component to be reduced by 30% or more compared to the case where the equivalent inductance ratio is 1.

Furthermore, by adopting the configuration including the additional inductor 601, a secondary effect is that a more appropriate operation can be achieved even if the air gap of the inductor 205 is narrowed. This allows the leakage magnetic field from the inductor 205 to be reduced. Consequently, in the embodiment, it is possible to improve image quality by reducing noise caused by the leakage magnetic field in the image captured by the imaging device 101.

As the added inductor 601, an inductor having a small inductance value for suppressing current fluctuation in the flash emission mode may be selected. This makes it possible to make the leakage magnetic field from the inductor 601 also become smaller than that in the case where an air-core coil serving as the comparative example is only used.

Note that either an air-core coil or a coil with a magnetic core can be used as the inductor 601. However, since the direct current superposition characteristic is to be realized by the inductor 205, in one embodiment, an air-core coil that does not have the direct current superposition characteristic for the inductor 601 is used.

### Examples

### Example 1

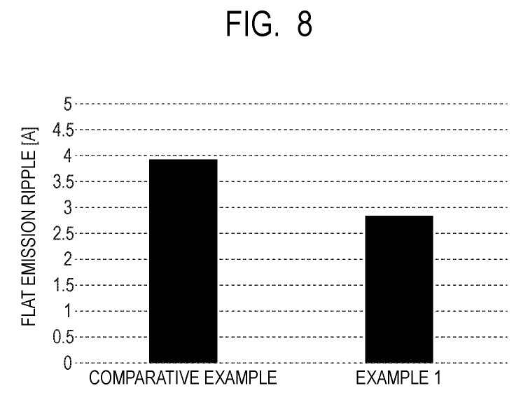

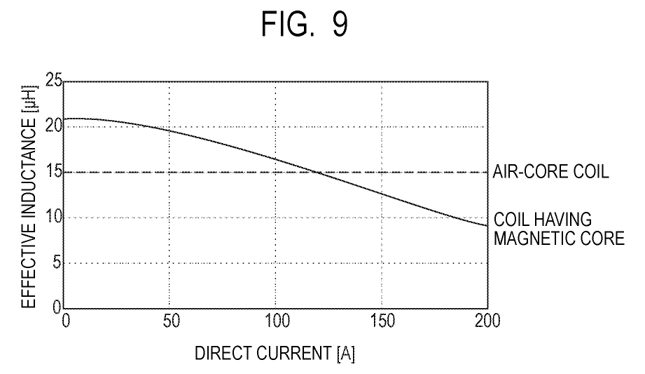

FIG. 8 is a graph in which a circuit simulation was performed for the flash light-emitting device 100 according to the first embodiment as Example 1, and the ripple current at the time of light emission in the flat emission mode was compared with a comparative example. In the circuit simulation, the peak current at the time of flash emission was set to 200 A, and the average current at the time of flat emission was set to 30 A. In the comparative example, an inductor of a 15 μF air-core coil having characteristics as shown by the broken line in FIG. 9 was used as the inductor 205. In Example 1, a coil having a magnetic core having characteristics as shown by the solid line in FIG. 9 was used as the inductor 205. Therefore, the inductor 205 of Example 1 had an effective inductance of 9.1 μH in the flash emission mode and 21 μH in the flat emission mode.

As a result of analyzing the light emission in the flash emission mode under the above conditions, it was confirmed that the peak current reached 200 A at the time when 17 μsec passed after the switching element 204 was turned ON in both the comparative example and Example 1.

Next, for the light emission in the flat emission mode, the switching operation of the switching element 204 was performed at 500 kHz, and the ON/OFF duty ratio of the switching element 204 was determined so that the average current became 30 A in both the comparative example and Example 1.

As a result of comparing the amount of ripple at the time of light emission in the flat emission mode under the above conditions, while the amount of ripple of 3.9 A was generated in the comparative example, the amount of ripple of 2.8 A was generated in Example b. Thus, it was confirmed that the amount of ripple in Example 1 was reduced by 28% compared to the comparative example. Since the ripple generates image noise called flicker noise as described above, it was confirmed that the flicker noise was reduced by Example b.

From the above comparison results, it was confirmed that the amount of ripple was suitably reduced at the time of light emission in the flat emission mode while securing a short rise time at the time of light emission in the flash emission mode by using a coil having a magnetic core as the inductor 205.

### Example 2

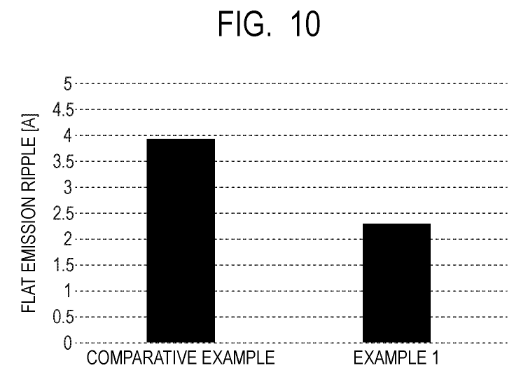

FIG. 10 is a graph in which a circuit simulation was performed for the flash light-emitting device 100 according to the second embodiment as Example 2, and the ripple current at the time of light emission in the flat emission mode was compared with a comparative example.

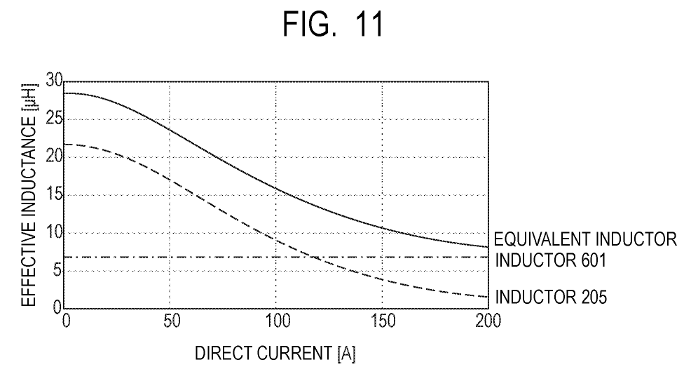

In the circuit simulation, the peak current at the time of flash emission was set to 200 A, and an average current at the time of flat emission was set to 30 A. In the comparative example, as in the comparative example for Example 1, a 15 μF air-core coil having characteristics as shown by the broken line in FIG. 9 was used as the inductor 205. In Example 2, a coil having a magnetic core having characteristics as shown by the broken line in FIG. 11 was used as the inductor 205. Therefore, the inductor 205 of Example 2 ha d an effective inductance of 1.5 μH in the flash emission mode and 20 μH in the flat emission mode. Furthermore, in Example 2, a 6.8 μF air-core coil having characteristics as shown by the dash-dot line in FIG. 11 was used as the inductor 601. Therefore, the equivalent inductance of the equivalent inductor of the inductor 205 and the inductor 601 in Example 2 had characteristics as shown by the solid line in FIG. 11, and was 8.3 μH in the flash emission mode and 26.8 μH in the flat emission mode.

As a result of analyzing the light emission in the flash emission mode under the above conditions, it was confirmed that the peak current reached 200 A at the time when 17 μsec passed after the switching element 204 was turned ON in both the comparative example and Example 2.

Next, for the light emission in the flat emission mode, the switching operation of the switching element 204 was performed at 500 kHz, and the ON/OFF duty ratio of the switching element 204 was determined so that the average current became 30 A in both the comparative example and Example 2.

As a result of comparing the amount of ripple at the time of light emission in the flat emission mode under the above conditions, while the amount of ripple of 3.9 A was generated in the comparative example, the amount of ripple of 2.3 A was generated in Example 2. Thus, it was confirmed that the amount of ripple in Example 2 was reduced by 42% compared to the comparative example.

From the above comparison results, it was confirmed that the amount of ripple was suitably reduced at the time of light emission in the flat emission mode while securing a short rise time at the time of light emission in the flash emission mode by adding the inductor 601 to the inductor 205 in the flash light-emitting device 100.

According to the disclosure, the light-emitting device can realize operation with a more appropriate inductance value of the inductor with a simpler configuration in both the flash emission mode and the flat emission mode.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-021074, filed Feb. 12, 2025, which is hereby incorporated by reference herein in its entirety.

What is claimed is:

1. A light-emitting device comprising:
a light-emitting component configured to emit light upon receiving a supply of electric power;
a capacitor configured to supply the electric power to the light-emitting component;
a switching element configured to control the supply of the electric power by turning ON and OFF; and
an inductor connected between the light-emitting component and the capacitor,
the light-emitting device having:
a first emission mode in which the switching element is turned ON to cause the light-emitting component to emit light over a first period, and thereafter the switching element is turned OFF; and
a second emission mode in which the ON and OFF of the switching element are repeated to cause the light-emitting component to perform continuous light emission over a second period longer than the first period,
wherein the inductor includes a core coil having a magnetic core,
wherein the core coil has a first inductance value during a peak current in the first emission mode, and has a second inductance value during an average current in the second emission mode, and
wherein the second inductance value is greater than the first inductance value.

2. The light-emitting device according to claim 1, wherein the inductor includes an inductor element connected in series with the core coil between the capacitor and the light-emitting component.

3. The light-emitting device according to claim 1, wherein the second inductance value is 1.3 times or more the first inductance value.

4. The light-emitting device according to claim 1, wherein a value of the average current is one-half or less a value of the peak current.

5. The light-emitting device according to claim 1, wherein the first period is less than 1 msec and the second period is 1 msec or more.

6. The light-emitting device according to claim 2, wherein a second equivalent inductance value of the core coil and the inductor element during the average current in the second emission mode is greater than a first equivalent inductance value of the core coil and the inductor element during the peak current in the first emission mode.

7. The light-emitting device according to claim 6, wherein the second equivalent inductance value is 1.5 times or more the first equivalent inductance value.

8. The light-emitting device according to claim 2, wherein the inductor element is an air-core coil.

9. The light-emitting device according to claim 8, wherein the core coil is a saturable inductor.

10. The light-emitting device according to claim 1, wherein the core coil is a choke coil.

11. The light-emitting device according to claim 1, wherein the magnetic core is a core composed of a soft magnetic material.

12. The light-emitting device according to claim 11, wherein the soft magnetic material is ferrite or permalloy.

13. The light-emitting device according to claim 1, wherein the light-emitting component is a flash discharge tube.

14. The light-emitting device according to claim 1, wherein the switching element is a compound semiconductor element.

15. The light-emitting device according to claim 1, wherein a time from when the switching element is turned ON until the switching element is turned OFF in the first emission mode is longer than a time from when the switching element is turned ON until the switching element is turned OFF in the second emission mode.

16. The light-emitting device according to claim 1, wherein the ON period frequency in the second emission mode is 20 kHz or more.

17. The light-emitting device according to claim 1, further comprising a control unit configured to cause the light-emitting component to emit light in the first emission mode or the second emission mode by controlling the switching element.

18. A flash device attachable to and detachable from a camera, the flash device comprising the light-emitting device according to claim 1.

19. A system comprising:
the light-emitting device according to claim 1; and
an imaging device having a sensor.

20. A method using an imaging device having a sensor and the light-emitting device according to claim 1, the method comprising:
imaging a subject by the imaging device.
